(19) United States
(12) Patent Application Publication
(10) Pub. No.: US 2023/0380402 A1
(43) Pub. Date: Nov. 30, 2023

(54) SYSTEM AND METHOD FOR ORCHARD PEST CONTROL

(71) Applicant: Jason FERRY, Cashmere, WA (US)

(72) Inventor: Jason FERRY, Cashmere, WA (US)

(21) Appl. No.: 18/249,494

(22) PCT Filed: Nov. 12, 2021
(86) PCT No.: PCT/US2021/059183

§ 371 Date: Apr. 18, 2023

Related U.S. Application Data
(60) Provisional application No. 63/117,841, filed on Nov. 24, 2020.

(51) Int. Cl. A01M 5/04; A01M 7/00; A01M 5/02; A01M 3/00; A01D 46/26

(52) U.S. Cl. CPC A01M 5/04; A01M 7/0014; A01M 5/02; A01M 3/002; A01D 46/26; A01M 2200/012

(57) ABSTRACT

A tarp system for controlling psylla and other orchard pests that includes two or more tarps sized and shaped to fit the width of an orchard row, a roller with handle, a container, oil, a pole apparatus for dislodging pests, and a broom. A method for using the tarp system includes grounding a first tarp below a tree, saturating a roller with oil in the container, rolling oil onto the tarp with the roller, and tapping tree branches over the tarp to dislodge pests on to the tarp, placing a second tarp slightly under the first tarp, sweeping debris from the first tarp to the second tarp, and disposing of the second tarp.

### BACKGROUND

### Technical Field

The present disclosure pertains to orchard pest management and, more particularly, to the treatment and control of pear psylla (Cacopsylla pyricola) and other similar pests.

### Description of the Related Art

The pear psylla pest is believed to have arrived in the United States in Connecticut in 1832, and from there it spread to Washington State by the late 1930s. It is considered to be a serious pest to pear orchards in the Pacific Northwest because psylla infestations can stunt, defoliate, and kill trees.

Nymph and adult psylla feed on the plant phloem. Nymphs produce honeydew, which drips or runs onto the fruit, causing dark blotches or streaks. When pear psylla reach large numbers, their activities can stunt and defoliate trees and cause fruit drop, and in some cases fruit set can be reduced the following year. These symptoms, called psylla shock, are caused by toxic saliva injected into the tree by feeding nymphs. Pear psylla can also inject disease into trees via its saliva that damages sieve tubes in the phloem, preventing synthesized nutrients from moving down the tree. This can result in root starvation.

Adoption of resistant root stocks have helped to reduce the damage cause by psylla. Chemical control through the use of pesticides is the most common method, although this causes concern for human health and is unsuitable for organic growers. In addition, chemicals can injure or kill natural predators to the pear psylla and other pests.

### BRIEF SUMMARY

In accordance with one implementation of the present disclosure, two systems and related methods of controlling pear psylla are disclosed herein—the tarp system and method and the wall system and method. These two systems may be used individually or in combination as described briefly below and in more detail in the Detailed Description.

Briefly, the tarp system includes two or more tarps sized and shaped to fit the width of an orchard row, a standard paint roller with a handle, a container, such as a five-gallon bucket, oil, such as spray oil (organic), a pole apparatus for use in dislodging the pests from the tree limbs, and a push broom.

In accordance with another implementation of the present disclosure, a method of using the tarp system is provided. The method includes spreading a first ‘tapping tarp’ tarp across the ground at the bottom of a tree. An optional grasping pole may be attached to the tarp to act as a handle for easy manipulation of the tarp. The method then proceeds to filling the container with the oil, and placing a paint roller into the container until saturated with the oil. The method continues with rolling the oil-coated paint roller onto the tapping tarp to coat the tapping tarp with a layer of oil. Once these preparatory steps are completed, the beating pole is used to dislodge the pear psylla from the tree by tapping on the leading tree branches that hang over the tarp. Tapping or beating at least once or twice towards the end of the tree branch leaders will dislodge the psylla onto the oil-coated tapping tarp where they are held on to the tarp by the oil. The method is repeated for each tree, continuing all the way down the row through the orchard.

In accordance with another aspect of the present disclosure, when the tapping tarp has accumulated psylla and other debris, the method includes moving the tapping tarp outside the drip line of the tree row and placing a second ‘debris tarp’ slightly under the tapping tarp, then sweeping the debris and entrained psylla from the tapping tarp to the debris tarp, such as with a standard push broom or other similar tool. When this is completed, the debris tarp is folded to prevent the escape of pests and accumulation of debris from wind or rain, and the debris tarp is then disposed. The foregoing method is repeated throughout the orchard by reapplying the oil to the tapping tarp after cleaning it to the debris tarp and then dislodging psylla from the trees.

In accordance with another implementation of the present disclosure, a catchment wall system is provided that includes an orchard speed sprayer mounted on a first movable platform, spray oil, a mobile trailer, and a portable screen mounted on the mobile trailer that is sized and shaped to be positioned in spaced parallel relationship with the speed sprayer on opposing sides of a row of orchard trees.

In accordance with a further aspect of the present disclosure, a method of using the foregoing catchment wall system is provided, the method including attaching the catchment wall to a mobile trailer, the trailer configured to be pulled or pushed by a tractor in an orchard row. The method further includes loading oil into the mobile speed sprayer, and positioning the speed sprayer and the catchment wall in spaced parallel relationship on opposing sides of a row of trees in an orchard, then activating the speed sprayer to spray oil through the tree and onto the catchment wall simultaneous with the speed sprayer and catchment wall moving in unison down their respective paths.

In accordance with another aspect of the present disclosure, the speed sprayer is configured or structured to spray the oil at a speed that as the oil spray is being applied, psylla in the tree to which the oil spray is being applied will go in flight from the leaves and branches of the tree and land or be pushed onto the catchment wall by the wind and turbulence created by the speed sprayer.

In accordance with a further aspect of the present disclosure, psylla that have landed on the catchment wall will continue to be pressed onto the catchment wall materials and saturated with the oil material to the point at which they drown.

In accordance with another aspect of the present disclosure, the catchment wall is built with a screen mesh for air movement to continue partially through the screen mesh. The catchment wall is preferably two inches thick on the frame with a screen mesh stapled to both sides of the wall. Ideally, the catchment wall is sized to accommodate both the trailer size and the height of the trees in the orchard.

In accordance with yet a further aspect of the present method, once the screen mesh on the portable catchment wall is coated with dead pests and other debris, it is cleaned with a water sprayer, after which it can continue to be used throughout the orchard rows.

In accordance with another aspect of the present disclosure, the foregoing tarp system and method and the wall system and method may be used consecutively, either with the tarp system first followed by the wall system or vice versa.

As will be appreciated from the foregoing, the present disclosure provides unique and effective systems and methods for control of pear psylla, a wide spread and damaging pest inherent in pear orchards throughout North America and beyond. The methods have been shown to dramatically reduce the number and persistence of the pest. These methods could also have beneficial and applicable uses for control of other pests such as coddling moth.

These methods provide an organic process that reduces the hatch and spread of the pest and therefore greatly reduces the damage done by the pest to the tree and its fruit. These methods can be used in conjunction with standard equipment as modified or constructed per the description that follows. Each grower should use the normal aqueous combinations of ingredients that have been designed for their orchard by their professional field agent in conjunction with the methods and systems disclosed herein. However, the present disclosed methods, taken alone or in combination, will reduce or eliminate the conventional chemical treatments used for control of the pest.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an illustration of a pear psylla on a pear tree leaf;

FIG. 2 is an illustration of a tarp system formed in accordance with the present disclosure as used in an orchard of pear trees;

FIG. 3 is a flow chart illustrating the method or process of orchard control utilizing the tarp system of FIG. 2;

FIG. 4 is an illustration of a catchment wall system formed in accordance with the present disclosure as used in an orchard of pear trees; and

FIG. 5 is a flow chart illustrating the method or process of orchard control utilizing the catchment wall system of FIG. 4.

FIG. 6 is an illustration of pear psylla caught on a catchment wall screen.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with orchard speed sprayers, tow vehicles, tractors, trailers, tarps, and brooms, and the like, have not been shown or described in order to avoid unnecessarily obscuring descriptions of the implementations and because such are known and readily commercially available.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

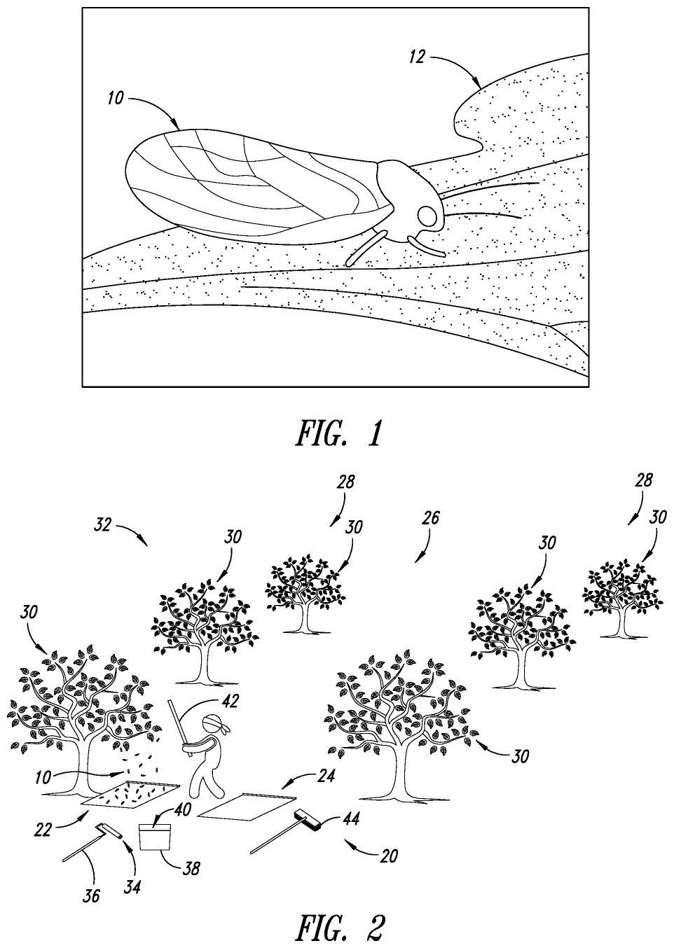

The present disclosure is described in the context of treating an orchard of pear trees for the pear psylla pest. As shown in FIG. 1, the pear psylla pest 10 can be found on the leaves 12 and branches of orchard trees, particularly pear trees. It is to be understood that the implementations described herein can be modified or expanded to address orchards of different type trees and different pests on either a pear tree or in orchards of other types of trees. More particularly, the systems and methods disclosed herein are applicable to other pests and may be used in greenhouses, nurseries, and in connection with other trees, bushes, and plants as well as to treat for pests other than the pear psylla pest.

### Tarp Treatment System and Method

In accordance with one implementation of the present disclosure, a tarp treatment system 20 is provided that, as shown in FIG. 2, includes at least two or more tarps 22, 24 that are sized and shaped to fit the width 26 of at least one tree, preferably a pear tree 30, in an orchard 32 of trees 30 that are arranged in rows 28 of trees 30. The system 20 further includes a roller 34, such as a readily commercially available standard paint roller, preferably with a four-foot handle 36, a container 38, such as a five-gallon bucket, oil (organic) 40, a pole apparatus 42 for use in dislodging the pets for the tree limbs, and a push broom 44 or other device to sweep debris from the first tarp 22 to the second tarp 24, also referred to as a debris tarp 24.

The foregoing components can be modified to suit the particular needs of the orchard in which the tarp treatment method 49 will be used. For example, without limiting the scope of the claims, the handle 36 and the pole apparatus 42 can each be of varying lengths or telescopic poles may be used to provide adjustability in their length. With respect to the oil, each grower should use the normal aqueous combinations of ingredients that have been designed for their orchard by their professional field agent in conjunction with the methods and systems disclosed herein.

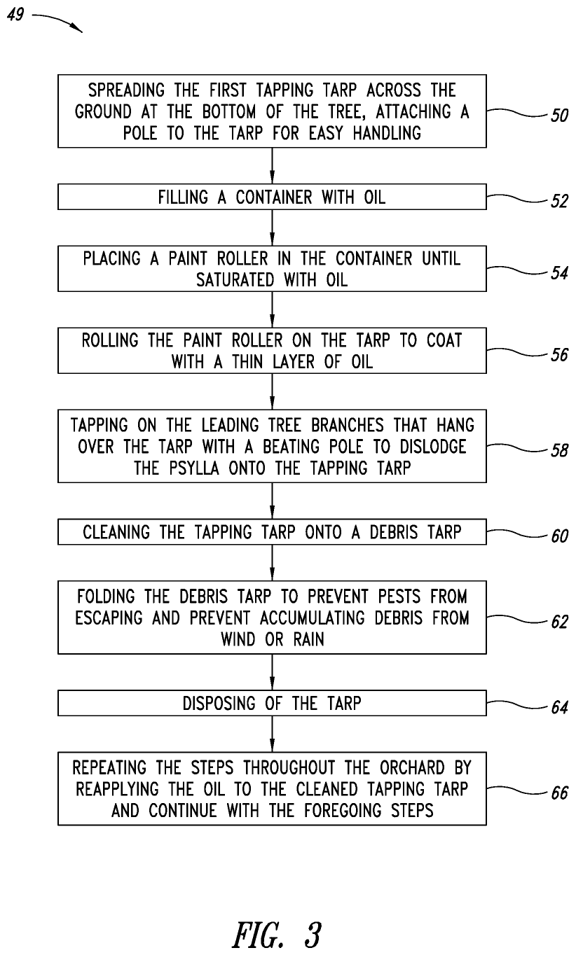

In accordance with another implementation of the present disclosure, a method 49 of using the above-referenced tarp system 20 is provided as described below in conjunction with FIGS. 2 and 3. The method 49 includes preparatory steps that may be done in any order, including at an initial step 50 of first spreading the first ‘tapping tarp’ 22 across the ground at the bottom of a selected tree 30. An optional pole (not shown) can be attached to one edge of the tapping tarp 22 to provide a means for grasping the tarp and for keeping the tarp flat and open as it is being moved from tree to tree. At a next step 52, the container 38 is partially filled with the oil 40. It is to be understood that these first two steps 50, 52 are preliminary and may be reversed without impacting the removal and capture of the psylla.

After the oil 40 is in the container 38, the paint roller 34 is placed into the container 38 at a further step 54 to obtain oil 40 on the roller 34. Ideally the roller 34 remains in the container until the paint roller 34 is saturated with the oil 40. In the next step 56, the oil-coated paint roller 34 is then rolled across the exposed (top) surface of the tapping tarp 22 to coat the tarp 22 with a layer of oil 40. The oil 40 should not pool on the tarp 22 in order to avoid waste.

After the foregoing preparatory steps 50, 52, 54, 56, the next step 58 involves using the beating pole 42 by tapping a distal end of the pole 42 on the leading tree branches that hang over the tapping tarp 22. Tapping or beating the pole 42 at least once or twice towards the end of the tree branch leaders facilitates the dislodging of the psylla from the branches and leaves of the tree 30, causing them to fall by gravity onto the tapping tarp 22 positioned below the tree branches. As the psylla 10 contact the oil on the tarp 22, they will adhere to the tarp 22 and be unable to escape. The method is repeated for each tree 30, moving the tapping tarp 22 down the row 28 through the orchard 32. The tarp 22 may be moved manually or mechanically, such as with a tractor, four-wheeler, ATV, or other land vehicle.

In accordance with another aspect of the present disclosure, when the tapping tarp 22 has accumulated psylla 10 (and any other debris), the method includes, at a further step 60, moving the tapping tarp 22 outside the drip line of the tree row 28 and placing the second ‘debris tarp’ 24 slightly under the tapping tarp 22, then cleaning the debris from the tapping tarp 20 to the debris tarp 22, such as with the standard push broom 44. Then at a following step 62, once the tapping tarp 20 is cleaned, the debris tarp 22 can be folded to prevent the escape of pests and prevent accumulation of debris from wind or rain. The folded debris tarp 22 can then be disposed 64. At step 66, the foregoing steps are repeated to continue the process throughout the orchard 32 by reapplying the oil to the tapping tarp 20 after cleaning it on to the debris tarp 22. If necessary the container can be replenished with the oil.

Other methods of tapping may be employed alone or in combination. For example, instead or or in addition to manually tapping the branches, tapping may be done mechanical, such as with a motor driven arm that is carried by hand or mounted to a movable platform, such as a trailer or vehicle.

### Wall Treatment System and Method

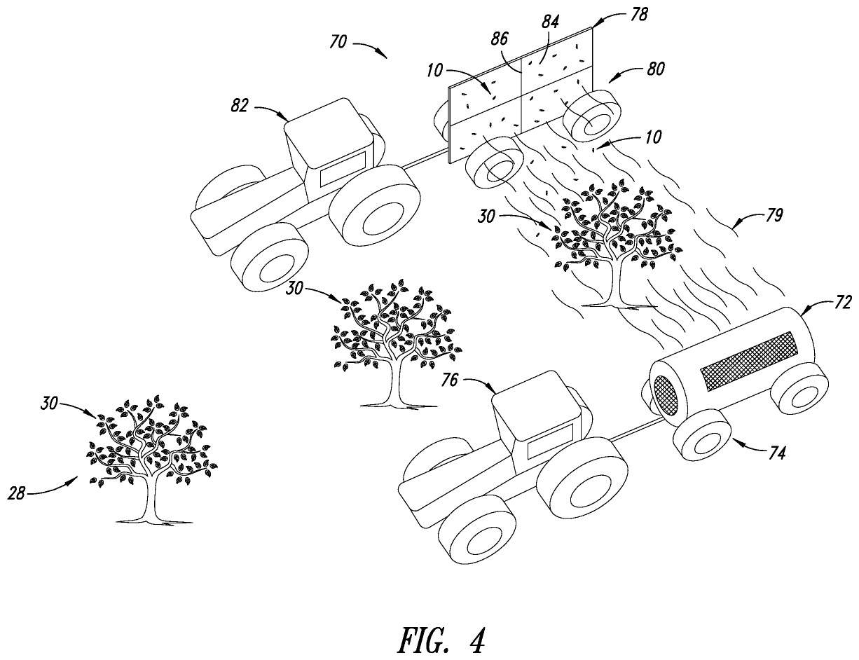

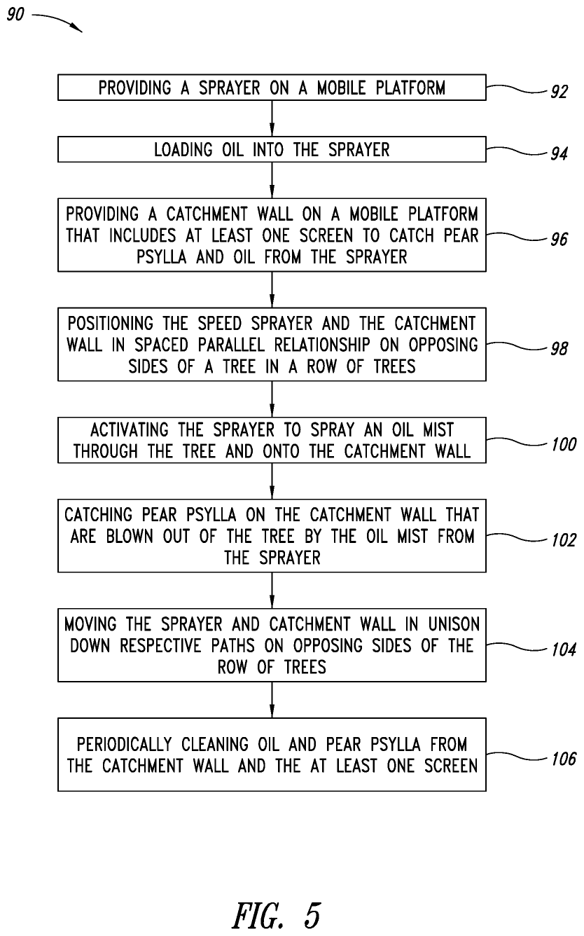

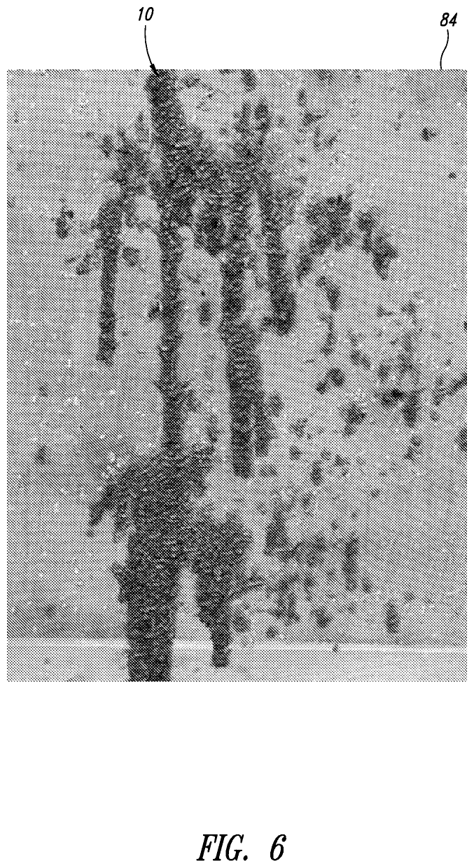

In accordance with another aspect of the present disclosure, a wall treatment system 70 for removing pear psylla 10 from trees 30 is provided, which is illustrated in FIG. 4, and to be used in conjunction with a method 90 of use as illustrated in FIGS. 5 and 6.

The wall treatment system 70 includes a portable sprayer 72 mounted on a movable platform, such as a trailer 74 that is towed by a vehicle 76, in this case a tractor. Ideally the sprayer 72 is a readily commercially available orchard speed sprayer 72 that will not be described in detail herein. Generally, a 400 gallon sprayer would provide application for four acres using the disclosed method. The pressure is typically 150 pounds and the sprayer moves over the ground at about 1.5 miles per hour. This is in accordance with the spray recommendations for a test orchard where the inventor's testing has primarily occurred. These parameters can be altered according to the needs of each particular orchard. It is to be understood that the sprayer 72 is structured to blow both air and moisture as part of its function.

While a typical sprayer holds 400 gallons—the majority of which is water—a combination of other materials (such as Surround, stickers such as NuFilm or Pinene) would be the same proportions as the ‘spray recommendations’ from the field agent. Local governments, such as the federal government as well as states and counties, highly regulate how any sprays are prescribed and applied by licensed professionals. Each orchard is different (geography, time of year of the spray, stage of growth of insects like Psylla, area surrounding the orchard, etc.), which is why spray recommendations are designed by a field agent for each grower individually. Growers have to provide proof of an applicator's license as well detailed spray records (matching their agent's spray recommendations), which are reviewed by the government via an audit.

Part of the simplicity of the present disclosed systems and methods lies in the fact that the grower (and field agent) do not have to change the way they have mixed and applied their sprays. It is more or less the same way they have been doing it. And variations of the systems and methods disclosed herein are possible. For example, a grower could indeed use the wall method with just water in the sprayer, which could be in addition to their regular spray method as prescribed by the field agent.

The system 70 further includes a movable catchment wall 78 that can be mounted on a trailer 80 to be towed behind a second vehicle 82. The vehicle 82 may be a tractor, all terrain vehicle, motorcycle, four-wheeler, or other land vehicle. In one implementation the catchment wall 78 is built with a screen mesh 84 to enable air to move at least partially through the screen mesh while retaining sprayed oil and psylla 10 on the screen mesh 84. The catchment wall 78 is preferably two inches thick and is mounted on a frame 86 that is sized and shaped to accommodate both a size of the trailer and a height of the at least one tree 30 in the orchard. The screen mesh 84 is attached to one or both sides of the frame 86.

The size of the screen mesh 84 needs to be small enough to catch the psylla, but large enough to allow wind and spray to go through without substantial resistance. In one implementation, it has been found that standard commercially available screen door mesh will work, and it can be metal or plastic mesh. Insect screen having a thickness of 0.125 inch and a mesh size in the range of 16×16 to 18×18 with a wire diameter in the range of 0.009 to 0.011 inch has worked satisfactorily.

In accordance with a method 90 of using the catchment wall 78, as shown in FIG. 5, the process includes preparatory steps of initially providing at a first step 92 the speed sprayer 72 on the movable platform 74 and then, at a second step 94, loading oil into the speed sprayer 72. At a third step 96, the portable catchment wall 78 is attached to or mounted on the mobile trailer 80, with the trailer being configured to be pulled or pushed by a tractor 82 along one side of a row 28 of trees 30 in an orchard. It is to be appreciated that the wall and the sprayer may be coupled together, either directly or through other coupling devices when the environment and the plants enable this to be effective. For example, an overhead gantry or connecting bar can be employed that passes over the tops of the plants as the connected wall and sprayer move along a row of plants.

Further preparatory to dislodging the psylla 10 from the trees 30, at a further step 98, the process requires positioning the speed sprayer 72 and the catchment wall 78 in spaced parallel relationship on opposing sides of a row 28 of trees 30 in the orchard. Then at a subsequent step 100, the sprayer 72 is then activated to spray a mist 79 of air and oil through the tree 30, dislodging psylla 10 from the tree 30 and, at a following step 102, catching the dislodged psylla 10 on the catchment wall 78 with, at another step 104, the simultaneous movement of the sprayer 72 and the portable catchment wall 78 and in unison down their respective paths on each side of the row 28 of trees 30. In one implementation, the sprayer pressure is typically 150 pounds and the sprayer 72 and catchment wall 78 move over the ground at about 1.5 miles per hour.

The wall method typically removes the bulk of psylla and material from the sprayer 72 and wall 78 while in operation. Hence, clean up afterwards involves just washing off the catchment wall 78 and the sprayer. As shown in FIG. 6, the screen mesh 84 can be covered with psylla 10. When this occurs the process, at a next step 106, includes periodically cleaning the entrapped psylla 10 from the screen mesh 84, such as spraying the screen with water from a hose or pressure washer. By having screen mesh 84 on both sides of the wall, any psylla that make it to the wall will generally not escape through the wall. In addition, the wall 78 functions to prevent spray drift, even with screen mesh on one side of the wall frame 86. Preventing spray drift will provide extra protection for beneficial insects, such as predator insects. The result is a strong Integrated Pest Management (IPM) system, which will also manage “mites,” that in turn means less miticides are used.

During operation, the spray exits from the sprayer 72 and impacts the wall 78 with a vortex pattern. The vortex will stream in the direction from which the moving wall 78 came. The result is a more focused application of the pesticide that minimizes drift, results in non disturbance in untreaded areas, and maximizes kill by preventing escape of pests from the area being sprayed by the sprayer 72.

After the catchment wall 78 is cleaned, the method then continues as described above.

It will be appreciated that the foregoing catchment wall system and method can be adapted for use in other environments, such as a greenhouse. One greenhouse implementation would use tracks in which the wall and the sprayer are mounted on respective tracks and are moved simultaneously or in coordination with each other on their respective tracks down each row of plants. The sprayer and wall may be electrically powered, such as with solar power provided by a solar panel or panel array associated with the greenhouse.

In addition to the foregoing, a computer implemented control system may be employed for one or both of the wall and the sprayer in any of the foregoing environments. The computer-implemented control system would use conventional computers configured to operate according to pre-programmed instructions or real-time instructions operating in conjunctions with sensors in the orchard or greenhouse that adjust the movement speed, amount of spray, wind speed, etc., in accordance with either pre-programmed instructions or instructions modified by data from live sensors.

It is to be understood that the two methods 49, 90 and systems 20, 70 described above can be used individually or together. However, with respect to timing, the tarp method should be used when there is no fruit on the trees, as well as when the fruit buds have not been swelled to the point the buds can be knocked off due to tapping. The wall method can be used at any time the wall trailer and sprayer unit can be moved down the rows in the orchard.

It will be appreciated from the foregoing and the accompanying drawings that this system and method can be used in orchards, greenhouses, nurseries and other environments with a variety of plants to control numerous types of pests. A multiple variety of commodities, such as sprayers and other equipment, including the shape of the wall, can be used in accordance with the present disclosure as known to those skilled in the art. In addition, more advanced technologies may be employed, such as drones.

For example, a single or multiple drones may be used to hold and move the wall 78 while a single or multiple drones may be used to hold and move the sprayer 72. Drone swarm technology may be used to control multiple drones with a single wall 78 and sprayer 72 or for simultaneous deployment of multiple walls 78 and sprayers 72, as is known to those in the drone technology field.

A further implementation of any of the foregoing embodiments may employ lights on the wall to attract codling moths, other moths and pests, to enhance efficacy of the system and method disclosed herein.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A system for treating an orchard for pear psylla pests, the orchard having at least one pear tree, the system comprising:
oil;
two or more tarps sized and shaped to fit a width of an orchard row;
a paint roller with a handle;
a container sized and shaped to receive the paint roller and the oil;
a beating pole apparatus sized and shaped for use in manually dislodging psylla pests from the at least one pear tree; and
a tool to clean a second tarp of the two or more tarps.

2. The system of claim 1 wherein the handle has a length of at least four feet.

3. The system of claim 1 wherein the container is a five-gallon bucket.

4. The system of claim 1 wherein the pole apparatus is four to twelve feet in length.

5. The system of claim 1 wherein the tool to clean the second tarp is a push broom.

6. The system of claim 1 wherein the pole apparatus is adjustable in length.

7. A method for using a tarp system to control psylla pests in an orchard having at least one pear tree, the tarp system including oil, a tapping tarp sized and shaped to fit a width of an orchard row, a paint roller with a handle, a container sized and shaped to receive the paint roller and the oil, a beating pole apparatus sized and shaped for use in manually dislodging psylla pests from the pear tree, and a push broom, the method comprising:
spreading the tapping tarp across the ground at a bottom of a tree;
attaching a pole to the tarp for easy handling;
filling the container with the oil;
placing a paint roller into the container until the paint roller is saturated;
rolling the oil-coated paint roller onto the tapping tarp to coat the tapping tarp with a layer oil; and
tapping on leading branches from the tree that hang over the tarp with the beating pole at least once or twice towards ends of leaders on the tree branches to dislodge the psylla onto the tapping tarp.

8. The method of claim 7, comprising repeating the method of claim 4 for each at least one tree in the orchard.

9. The method of claim 7, further comprising when the tapping tarp has accumulated psylla and other debris, moving the tapping tarp outside a drip line of the at least one tree and placing a debris tarp at least partially under the tapping tarp, then sweeping debris from the tapping tarp to the debris tarp with a standard push broom, followed by folding the debris tarp to prevent escape of pests and accumulation of debris from wind or rain, and disposing of the debris tarp.

10. A catchment wall system for addressing pear psylla in an orchard having at least one tree, the system comprising:
an orchard speed sprayer;
oil suitable to be dispensed from the orchard speed sprayer;
a mobile trailer; and
a portable screen coupled to the mobile trailer and sized and shaped to be positioned in spaced parallel relationship with the speed sprayer.

11. The system of claim 10 wherein the speed sprayer is structured to spray the oil at a speed such that as the oil is sprayed on the at least one tree, psylla in the tree to which the oil spray is being applied will go in flight from leaves of the tree and land or be pushed onto the catchment wall by wind and turbulence created by the speed sprayer.

12. The system of claim 10 wherein the catchment wall is built with a screen mesh to enable air to move at least partially through the screen mesh.

13. The system of claim 10 wherein the catchment wall is preferably two inches thick and is mounted on a frame and is sized and shaped to accommodate both a size of the trailer size and a height of the at least one tree in the orchard.

14. A method of using a catchment wall system that includes an orchard speed sprayer; oil suitable to be dispensed from an orchard speed sprayer, a mobile trailer, and a portable screen coupled to the mobile trailer sized and shaped to be positioned in spaced parallel relationship with the speed sprayer, the method comprising:
attaching the portable screen to the mobile trailer, the trailer configured to be pulled or pushed by a tractor in an orchard row;
loading oil into the speed sprayer;
positioning the speed sprayer and the catchment wall in spaced parallel relationship on opposing sides of a row of trees in the orchard; and
activating the speed sprayer to spray oil through the tree and onto the portable screen simultaneous with the speed sprayer and portable screen moving in unison down their respective paths.

15. The method of claim 14 wherein the spraying causes the oil to be sprayed at a speed such that as the oil spray is being applied, psylla in at least one tree to which the oil spray is being applied will go in flight from leaves of the at least one tree and land or be pushed onto the screen by wind and turbulence created by the speed sprayer.

16. The method of claim 14, wherein once the screen is coated with dead pests and other debris, cleaning the screen with a water sprayer.

17. A wall system for treating an orchard for pear psylla pests, the orchard having at least one pear tree, the wall system comprising:
a wall mounted on a first movable platform, the wall having an exposed face with a screen mesh configured to entrap the pear psylla pest upon contact of the pear psylla pest with the exposed face; and
a portable sprayer mounted on a second movable platform, the portable sprayer configured to spray an oil and generate a wind on the at least one pear tree with a force to dislodge the pear psylla pest from the at least one pear tree and blow the dislodged pear psylla pest onto the screen mesh on the wall and entrap the pear psylla pest on the screen mesh.

18. The system of claim 17 wherein the screen mesh is sized and shape to hold the oil and drown the pear psylla pest blown on to the wall by the portable sprayer while enabling air from the portable sprayer to pass through the screen mesh.

19. A method of using a catchment wall system that includes a mobile speed sprayer on a first mobile trailer; oil suitable to be dispensed from the sprayer, a second mobile platform having a vertical catchment wall with a portable screen, the method comprising:
attaching the portable screen to the mobile trailer, the trailer configured to be pulled or pushed by a tractor in an orchard row;
loading oil into the speed sprayer;
positioning the speed sprayer and the catchment wall in spaced parallel relationship on opposing sides of a row of trees in the orchard; and
activating the speed sprayer to spray oil through the tree and onto the portable screen simultaneous with the speed sprayer and portable screen moving in unison down their respective paths.
